(19) United States
(12) Patent Application Publication
(10) Pub. No.: US 2005/0108201 A1
(43) Pub. Date: May 19, 2005

(54) Method to query an embedded database

(75) Inventors: Jorge Abellan Sevilla, Paris (FR); Ricardo Muller Pareja, Montrouge (FR)

Correspondence Address: PEHR JANSSON, ATTORNEY AT LAW, 7628 PARKVIEW CIRCLE, AUSTIN, TX, 78731, US

(73) Assignee: Schlumberger Systemes, Montrouge (FR)

(21) Appl. No.: 10/497,740

(22) PCT Filed: Dec. 2, 2002
(86) PCT No.: PCT/IB02/05154

(30) Foreign Application Priority Data
Dec. 6, 2001 (FR) 01/16071

(51) Int. Cl. G06F 17/30

(52) U.S. Cl. 707/3

(57) ABSTRACT

The solution concerns a method to query a relational database stored on a computer comprising a microcontroller, said database comprising at least a table composed of columns and rows including data accessible via a cursor. The method includes the following steps: Before executing the cursor, declare a cursor by systematically selecting all columns in the table concerned by the cursor, execute the cursor, after execution, select columns using a SEARCH command capable of selecting columns in the cursor result.

### TECHNICAL FIELD

This invention concerns a method to query data stored in a database on a data processing device (also called a computer) such as a cellular telephone, an electronic assistant, a smartcard, etc. Note that a data processing device, also called a computer by those skilled in the art, is a programmable machine capable of processing information.

The example chosen to illustrate the invention is that of the smartcard. The language currently used on smartcards is a sub-assembly of SQL (Structured Query Language) called SCQL (Structured Card Query Language). SCQL is a relational database query language described in standard OSI 7816-7 published by ISO (International Standard Organisation).

More generally, the invention applies to any emerging or future database whose model would be similar to that of the relational model.

### STATE OF THE ART TECHNOLOGY

An SQL database includes objects. These objects are generally known as tables, views and dictionaries. Note that a view is a logical sub-set of a table which defines the accessible part of a table. A view on a system table is called a dictionary. In the remainder of the description, to ensure that the description is clear, the term table will refer to a table, a view or a dictionary.

Each table is a structured data object with a unique name. It consists of named columns and a sequence of rows.

Various operations can be performed on a table. These operations are:
Read data,
Insert data,
Update data,
Delete data.

SQL language also proposes a range of commands to query databases. However, this language, although it is currently the language most frequently used to query DBMS databases, is not at all suitable for the smartcard environment. The current structure of a smartcard presents extreme hardware constraints and the query requests proposed by this language present the disadvantage of using too many physical and software resources in the card. Consequently, these constraints limit the query performance in the smartcard. This limitation has consequences especially during the execution of database query requests. The excessive consumption of resources is mainly due to verification of the compatibility rules which must be respected. These compatibility rules are based on relational algebra and are verified on the set of attributes (tables and columns) of a cursor before its execution. Due to this excessive consumption of resources, it is impossible to carry out operations between the database tables efficiently.

### THE INVENTION

An objective is therefore to improve the query performance of the smartcard.

In order to achieve this objective, the solution includes the following steps:
Before executing the cursor, declare a cursor by systematically selecting all columns in each table concerned by the cursor,
execute the cursor,
After execution, select columns using a SEARCH command capable of selecting columns in the cursor result.

Consequently, the selection of columns is not specified in the cursor declaration but is achieved by a specific command after obtaining the cursor result. Verification of the compatibility rules before execution of the cursor is then considerably reduced, making it possible to perform complex operations between tables. The invention also concerns the computer program including program code instructions for the execution of the following steps:
A first step to execute a cursor, said cursor being declared to systematically select all columns in each table concerned by the cursor,
A second step to select columns using a SEARCH command capable of selecting columns in the cursor result.

Lastly, the invention concerns the data processing device, especially a smartcard, storing a relational database comprising a microcontroller, said database comprising at least a table composed of columns and rows including data accessible via a cursor, characterised in that it comprises
means to declare a cursor and to systematically select all columns in each table concerned by the cursor, before executing the cursor
means to execute the cursor,
means to select columns in the cursor result, after execution.

It will be easier to understand the invention on reading the description below, given as an example and referring to the attached drawings.

### IN THE DRAWINGS

FIG. 1 is a block diagram view of the architecture of a computer system on which the solution can be applied.

FIG. 2 is a conceptual view of the computer system representing the programming interface capable of converting SQL into SCQL and vice versa.

FIGS. 3A and 3B are views of tables including data on which comparison operators can be applied.

FIG. 4 is an algorithm illustrating the main steps of an operation.

### DETAILED DESCRIPTION OF EXAMPLES ILLUSTRATING THE INVENTION

To simplify the description, the same elements illustrated in the drawings have the same references.

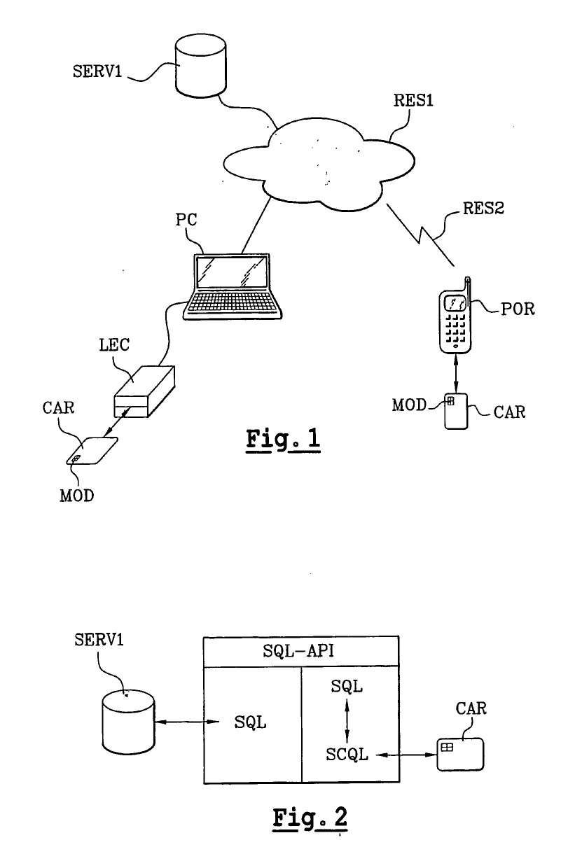

FIG. 1 represents a computer system SYS on which the method of the invention can be implemented. This system includes a number of servers connected together via a network RES1 (LAN, WAN, Internet, etc.). In our example, this system includes a server SERV1. This server is a database whose data language is SQL, known by those skilled in the art.

In our example, a cellular telephone POR communicates with this server SERV1 to exchange data. The telephone includes a smartcard CAR including an electronic module MOD. The data exchange between a server SERV1 and a cellular telephone POR may consist, for example, of updating the data stored in the smartcard CAR.

The invention is not limited to this example of realisation. Any device, such as a reader LEC connected to a PC, could have been used as an example to illustrate the invention.

The cellular telephone POR and the module MOD exchange data according to a data protocol, preferably the standardised protocol T=0 defined in standard ISO 7816-3.

The module MOD includes a microcontroller MIC and contacts to communicate with the exterior. Generally, a microcontroller includes:
a microprocessor CPU to execute the commands,
non volatile memories ROM (Read Only Memory), whose content is burnt in the factory and therefore cannot be modified. An encryption algorithm, the operating system SE, application programming interfaces (API), etc. can therefore be written in the ROM;
non volatile memories, for example EEPROM (electrically erasable programmable read only memory). It is generally used to store data specific to each card, for example the cardholder identity, the access rights to the services, the file systems, all the application programs of the card, etc.
volatile memories RAM, work space to execute the card commands,
security units CRYP for data encryption,
units taking into consideration the power supply voltage, clock speed, etc.,
a data bus connecting everything,
an input-output bus to communicate, in our example of realisation, with the cellular telephone POR.

The operating system has a command set which it can execute upon request. It manages the communication with the exterior, using a standardised and secured communication protocol. The commands given are validated by the operating system before being executed (validation of user privileges). It may contain confidential information since it carries out itself an access check on its secured files.

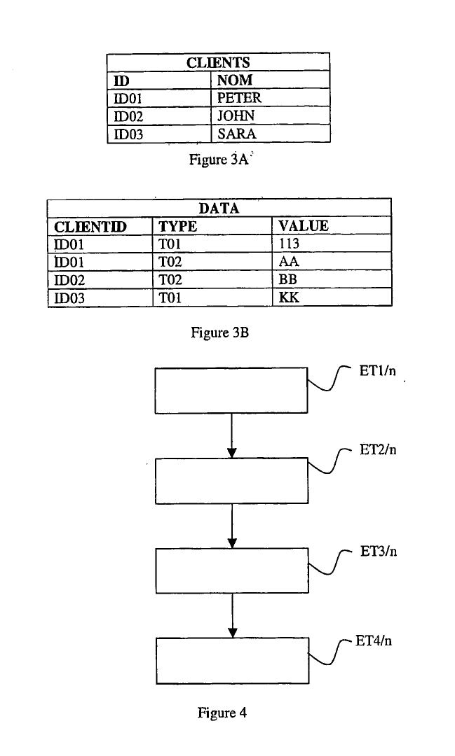

A relational database query language is used to store data in the card. In our example, the query language is SCQL. An API, known by those skilled in the art, converts SQL commands into SCQL commands and vice versa. FIG. 3 shows a diagrammatic representation of the card, a server and the API. The API converts SQL commands into SCQL commands and vice versa.

FIGS. 3A and 3B represent two examples of tables called CLIENTS and DATA, respectively.

In our example of realisation, the CLIENTS table comprises two columns. A first column ID comprises the client identifier and a second column NAME comprises the name of the respective client. These two names CLIENTS and DATA are generally called relation by those skilled in the art. In our example, three identifiers ID01, ID02 and ID03 identify three clients whose names, respectively PETER, JOHN, and SARA, are shown in the column NOM.

The table DATA comprises three columns CLIENTID, TYPE, and VALUE designating respectively,
the client identifier ID01, ID02 and ID03,
its type T01, T02, and T03,
a value 113, AA, BB.

Generally, an SCQL operation called “DECLARE CURSOR” is written as follows:
DECLARE CURSOR AS SELECT <Column name> [,<column name>, . . . ] FROM <table name> [WHERE <condition> [ AND <condition>, . . . ]
<Column name> [,<column name>, . . . ] and <table name> represent the set of attributes of the cursor.

A problem is that this declaration can only be used to query a single table. The hardware constraints of the smartcard prevent complex operations, for example joins between tables. The excessive consumption of resources is mainly due to verification of the compatibility rules which must be respected. These compatibility rules are based on relational algebra.

These rules are verified for the set of attributes of a previously defined cursor.

FIG. 4 illustrates the various steps of the method which will be used as an illustration of the solution. The illustration is based on a request which consists of performing the following 3 operations on the above-mentioned tables CLIENTS and DATA:
A first operation OP1 consists of a comparison between two columns of two tables in order to join the lines in the two tables which contain the same value ID and CLIENTID,
A second operation OP2 consists of a comparison with a string in order to join the lines in the two tables in which the value of the type column is T01.

A third operation OP3 consists of performing an operation between the previous two cursors.

Each operation OPn (n=0, 1, 2, 3) comprises a series of steps including the following (ET1/n, ET2/n,ET3/n):

A first step ET1/n consists of declaring a separate cursor C1, C2 and C3 for each respective operation OP1, OP2 and OP3 to be performed. Several cursors will therefore coexist in the same database. Each cursor has a unique name used to identify it in all the operations it is involved in. The declaration also consists of not specifying any column in the <list> field defined previously. The list field is then completed by the “*” operator meaning that all columns in the selected tables are selected. Advantageously, this field can be written by default in the declaration to avoid saturation due to excessive consumption of resources.

The cursor declaration is then written as follows:
DECLARE CURSOR <Cn> AS SELECT * FROM <table name> [,<table name>, . . . ][WHERE <condition> [AND <condition>, . . . ].

A second step ET2/n consists of executing the cursor Cn,

A third step ET3/n consists of obtaining the cursor result(s) and of retrieving the result(s) as a list including sets, each set identifying the rows in the tables meeting the condition defined in the cursor. In our example of realisation, a row is identified by the number of the row in the table concerned.

A fourth step ET4/n consists of storing the list obtained in memory.

When a cursor, which will be called the main cursor, consists of an operation involving at least one cursor, an additional step ET1 bis/n is performed consisting of verifying the compatibility between selected columns and tables of each cursor. Preferably, this step ET1 bis is carried out before executing the main cursor. For example, if a main cursor consists of making an intersection between two cursors and the tables selected are not the same, we speak of incompatibility. If the compatibility test is positive, the method continues at step ET2/n. Conversely, if this test fails, the cursor in question is not executed.

In our example of realisation, the resolution of operations OP1, OP2, OP3 is carried out as follows:

Operation OP1:

A first step ET1/1 consists of declaring the first cursor by giving it a unique name C1.

The corresponding SCQL command is written as follows:
DECLARE CURSOR C1 AS SELECT * FROM clients,data WHERE clients.id=data.clientid

A second step ET2/1 consists of executing the EXEC command to open said cursor C1. It is written as follows:
EXEC CURSOR C1

Execution of this command consists of scanning the selected tables and verifying the condition written in the declaration via a scanning program.

After executing the EXEC command, in step ET3/1, in our example of is realisation, the result is supplied as a hit list: (1,1; 1,2; 2,3). In our example, each hit includes two digits. The first digit refers to the line number of the first table selected CLIENTS and the second digit refers to the line number of the second table selected DATA. For example, the hit (1,1) means that the first line of the table PLIENTS and the first line of the table DATA satisfy the operation OP1 defined in cursor C1.

In step ET4/n the result is stored in memory.

Operation OP2:

A first step ET1/2 consists of declaring the second cursor by giving it a unique name C2.

The corresponding SCQL command is written as follows:
DECLARE CURSOR C2 AS SELECT * FROM clients, data WHERE data.type=‘T01’

A second step ET2/2 consists of executing the EXEC command defined in standard OSI 7816-7 to open said cursor C2.

It is written as follows: EXEC CURSOR C2

Execution of this command consists of scanning the selected tables and verifying the condition written in the declaration via a scanning program. The scanning of the tables can be implemented according to any method.

As with operation OP1, after executing the EXEC command, in step ET3/2, the result obtained is logically the following three hits: (1,1; 2,1; 3,1).

In step ET4/2 the result is stored in memory.

Operation OP3:

A first step ET1/3 consists of declaring the third cursor by giving it a unique name C3.

The corresponding SCQL command is written as follows:
DECLARE CURSOR C3 as C1 UNION C2

Since cursor C3 refers to an operation between existing cursors C1 and C2, before executing cursor C3, in step ET1 bis/3, a compatibility test is carried out. Cursor C3 refers to a union between two tables “Clients” and “data”.

The compatibility test being positive, a second step ET2/3 consists of executing the EXEC command to open said cursor C2.

It is written as follows:
EXEC CURSOR C3

Execution of this command consists of writing in a single list the hit lists obtained with cursors C1 and C2, preferably eliminating the double entries.

After executing the EXEC command, in step ET3/3, the result obtained is the following hit list (1,1; 1,2; 2,3; 2,1; 3,1). Preferably, the hits obtained as result are stored in a list indicating the table lines which meet the condition stated in the declaration.

In step ET4/3 the result is displayed and possibly stored in memory.

At this stage of the method, the three operations OP1-OP3 are finished. The lists obtained as results only give as result table lines. In this case, the result obtained for cursor C3 is the hit list (1,1; 1,2; 2,3; 2,1; 3,1) indicating that the result of cursor C3 includes
the first line of table CLIENT and the first line of table DATA,
the first line of table CLIENT and the second line of table DATA,
the second line of table CLIENT and the third line of table DATA,
the second line of table CLIENT and the first line of table DATA,
the third line of table CLIENT and the first line of table DATA.

According to the principle of the invention, columns are no longer selected in the cursor declaration. It is carried out using a “SEARCH” command. As well as the names of the data columns to be selected, this “SEARCH” command also indicates the name of the cursor concerned by the column selection.

For example, the values of the “clients.nom” and “data.value” columns can be displayed in the hit lists of cursor C3.

The SEARCH command is written as follows:
SEARCH clients.nom, data.value FROM C3

Preferably, a command can be used to display the result(s) obtained. In our example, this GET command returns the data of the lines and columns concerned for display. The GET command is written as follows:
GET FROM C3

In our example of realisation, the GET command will transmit the following five results:
The name PETER and the value 113.
The name PETER and the value AA.
The name JOHN and the value BB.
The name JOHN and the value AA.

The name SARA and the value 113.

Several ways of displaying the result can be considered.

In a first mode, for example, the GET command displays all the results in a single block on the computer screen.

In a second mode, the GET command could display each result successively, hit by hit. For example, a first call of the GET command returns a first result. A second call of the GET command will return a second hit, and so on. In our case, after the GET command has returned the fifth hit, if this command is called again, an information message will be displayed, for example “no more hits” indicating that there are no more hits in the hit list of cursor C3.

With the solutions provided, it is possible to execute complex requests; several types of cursor declaration can be produced. These cursors share the following characteristics
they have a unique name,
they select no column during an operation (as shown by the use of the operator “*” in our illustrated example).

A first type of cursor declaration concerns a comparison with a string. This declaration contains only one condition. It is the comparison between a column (of one of the tables selected by the cursor) and a byte string. According to the syntax defined above for cursor declaration, i.e.:
DECLARE CURSOR <cursor name> AS SELECT * FROM <table or cursor names> [WHERE <condition>]
the condition takes the following form:
<table name>.<column name> <comparison operator> <byte string>
where the comparison operator can be any of the following operators:
“smaller than”, “greater than”, “equal to”, “different from”, “smaller than or equal to”, “greater than or equal to”, “starts with” or “includes”, etc.

After being opened, the cursor will contain the list of all hits which meet the condition, i.e. all possible combinations of lines (in selected tables) which satisfy the cursor condition.

A second type of cursor declaration concerns the comparison between two columns. This declaration only has one condition. It is the comparison between two table columns selected by the cursor.

The condition takes the form:
<table name>.<column name> <comparison operator> <table name>.<column name>
where the comparison operator can also take the following values:
“smaller than”, “greater than”, “equal to”, “different from”, “smaller than or equal to”, “greater than or equal to”, “starts with”, “includes”, etc.

After being opened, the cursor will contain the list of all hits which meet the condition, i.e. all possible combinations of lines (in selected tables) which satisfy the cursor condition.

A third type of cursor declaration concerns an operation between two cursors. This declaration contains the declaration of an operation (intersection or union) between two existing cursors in the SCQL database.

The operation definition takes the form:
<cursor name> <operator> <cursor name>
where the operator can take the following values:
UNION or INTERSECTION

The result of this cursor will contain:
for INTERSECTION, the list of all hits common to both cursors.
for UNION, the list of all hits in either cursor or common to both cursors.

Generally, the method comprises the following steps:
Before executing the cursor, declare a cursor by systematically selecting all columns in the tables concerned by the cursor,
execute the cursor,
After execution, select columns using a SEARCH command capable of selecting columns in the cursor result.

Obviously, the cursor may concern a single table.

We have seen in our example of realisation that, when a cursor (C3) involves using at least two sub-cursors (C1,C2), one solution is to name each cursor during its declaration via a unique identifier (C1,C2,C3), then execute each cursor and select columns with the SEARCH command on the result of cursor (C3).

We have seen that, when declaring each cursor, all the table columns concerned by the cursor are systematically selected. The result of each cursor includes sets of values, each set including the identifiers of table rows meeting the condition(s) of the associated cursor. Preferably, each table row has a unique identifier. In our example of realisation, each row is identified by a number: the first row of a table will be identified by the digit 1, the second by the digit 2, and so on.

In our example of realisation, the SEARCH command includes as parameters the name of the cursor on which the column selection must be carried out as well as the names of the data columns to be acquired.

In our example, a GET command can be used to display the result(s) obtained. We have seen that this command includes as parameter at least the name of the cursor concerned. This command can of course include other parameters.

Consequently, the cursor can concern one or more tables (clients, data).

Preferably, we have seen that it was useful to store a field, in our example “*” by default when writing the cursor, the purpose of this field being to systematically select all table columns concerned by the cursor.

The result is a computer program including program code instructions for the execution of the following steps:
store the cursor declaration in memory,
execute the cursor,
After execution, transmit the cursor result according to the column selection carried out with a SEARCH command.

We now see that the invention offers numerous advantages.

The list field is then completed by the “*” operator meaning that all table columns concerned by the cursor are systematically selected. Consequently, no compatibility test is carried out at this stage, thereby considerably reducing the consumption of physical and software resources. The response times are acceptable, no matter how complex the query request may be.

Since all columns are systematically selected when executing the cursor, the result only gives the table rows which meet the cursor condition. The columns are selected during analysis of the results with the “SEARCH” command, thereby avoiding saturation of the resources used with respect to the response time and memory consumption.

Naming the cursors also provides another clear advantage. By naming the cursors, complex requests such as union or intersection between cursors can be made. Selecting the columns during analysis of the results also reduces the consumption of resources when the verification of compatibility rules is carried out on an operation between cursors, for example during an intersection between cursors. During this type of operation, the verification of compatibility rules is carried out between two sets of attributes associated with the respective cursors, for example C1 and C2 for the cursor C3 defined previously.

With the invention, selections can now be carried out between several tables (joins). This new type of named cursor can also be used to carry out requests in order to compare columns.

1. A method to query a relational database stored on a data processing device comprising a microcontroller, said database comprising at least a table composed of columns and rows including data accessible via a cursor, comprising:
before executing the cursor, declare a cursor by systematically selecting all columns in each table concerned by the cursors;
execute the cursor;
after execution, select columns using a SEARCH command capable of selecting columns in the cursor result.

2. The method according to claim 1, further comprising:
when a cursor (C3) involves using at least two sub-cursors (C1,C2), naming each cursor during its declaration via a unique identifier (C1,C2,C3), executing each cursor, and carrying out column selection with the SEARCH command on the cursor result (C3).

3. The method according to claim 1, wherein the result of each cursor includes sets of values, each set including the identifier of the row of each table meeting the condition(s) of the associated cursor.

4. The method according to claim 1 or 2, wherein the SEARCH command includes as parameters the name of the cursor on which the column selection must be carried out as well as the names of the data columns to be acquired.

5. The method according to claim 3, further comprising displaying the result(s) obtained with a GET command, this command including as parameter at least the name of the cursor concerned.

6. The method according to claim 1, further comprising storing a field (*) by default when writing the cursor, the purpose of this field being to systematically select all columns in the tables concerned by the cursor.

7. A computer program comprising program code instructions for the execution of the following steps:
a first step to execute a cursor, said cursor being declared to systematically select all columns in each table concerned by the cursor,
a second step to select columns using a SEARCH command capable of selecting columns in the cursor result.

8. A data processing device storing a relational database comprising a microcontroller, said database comprising at least a table composed of columns and rows including data accessible via a cursor, comprising:
means to declare a cursor and to systematically select all columns in each table concerned by the cursor, before executing the cursor
means to execute the cursor,
means to select columns in the cursor result, after execution.

9. A smartcard storing a relational database comprising a microcontroller, said database comprising at least a table composed of columns and rows including data accessible via a cursor, comprising:
means to declare a cursor and to systematically select all columns in each table concerned by the cursor, before executing the cursor,
means to execute the cursor,
means to select columns in the cursor result, after execution.

10. A computer readable storage medium storing a computer program including program code instructions for instructing a computer to execute the following steps:
a first step to execute a cursor, said cursor being declared to systematically select all columns in each table concerned by the cursor,
a second step to select columns using a SEARCH command capable of selecting columns in the cursor result.
